(19) United States
(12) Patent Application Publication
(10) Pub. No.: US 2025/0289166 A1
(43) Pub. Date: Sep. 18, 2025

(54) RECYCLING SYSTEMS AND RELATED METHODS

(71) Applicant: Altium Packaging LP, Atlanta, GA (US)

(72) Inventor: Khosrow Hallaji, Greensboro, NC (US)

(21) Appl. No.: 19/079,833

(22) Filed: Mar. 14, 2025

Related U.S. Application Data
(60) Provisional application No. 63/565,829, filed on Mar. 15, 2024.

(51) Int. Cl. B29B 17/02; B29B 17/04; B29K 23/00; B29K 105/26; C08L 23/06; C08L 23/12

(52) U.S. Cl. CPC B29B 17/02; B29B 17/0412; C08L 23/06; C08L 23/12; B29B 2017/0203; B29K 2023/065; B29K 2023/12; B29K 2105/26; C08L 2207/062; C08L 2207/20

(57) ABSTRACT

A method of producing fit-for-food contact devolatilized post-consumer thermoplastic polymer pellets derived from higher melt index post-consumer recycled thermoplastic polymer, in various aspects, comprises: providing higher melt index post-consumer recycled thermoplastic polymer having; forming the higher melt index post-consumer recycled thermoplastic polymer into a plurality of higher melt index polymer pellets; after forming the higher melt index post-consumer recycled thermoplastic polymer into the plurality of higher melt index post-consumer polymer pellets, devolatilizing the plurality of higher melt index post-consumer polymer pellets in a devolatilization chamber to produce a plurality of devolatilized higher melt index post-consumer polymer pellets; and providing the plurality of devolatilized post-consumer high-density polyethylene and polypropylene pellets for use in at least one of an injection molding, compression molding, or flexible packaging processes to produce a plurality of fit-for-food contact articles from the plurality of devolatilized post-consumer high-density polyethylene and polypropylene pellets.

### CROSS-REFERENCE TO RELATED APPLICATIONS

This application claims the benefit of U.S. Provisional Patent Application Ser. No. 63/565,829, filed Mar. 15, 2024, the entire disclosure of which is hereby incorporated herein by reference in its entirety.

### BACKGROUND

Current recycling techniques are unable to make effective use of particular components of post-consumer recycled articles, particularly when creating new products or materials from those post-consumer recycled articles using techniques that have particular material requirements with respect to those components. Accordingly, there is currently a need for improved techniques for preparing post-consumer recycled article components for use in new products or as raw materials that reduce waste and reuse of post-consumer materials.

### SUMMARY

In accordance with the purpose(s) of the present disclosure, as embodied and broadly described herein, the disclosure, in one aspect, relates to recycling post-consumer plastics for use in fit-for-food contact articles.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure. In addition, all optional and preferred features and modifications of the described embodiments are usable in all aspects of the disclosure taught herein.

A method of producing post-consumer recycled high density polyethylene or polypropylene pellets, fit-for-food contact for use in molding processes requiring higher melt index material, in various aspects, comprises: (1) providing a plurality of post-consumer high-density polyethylene and polypropylene bottle and containers caps, closures and lids derived from recycled plastic food grade bottles and containers; (2) grinding the plurality of post-consumer high-density polyethylene and polypropylene caps, closures and lids into a plurality of post-consumer high-density polyethylene and polypropylene flakes; (3) identifying and discarding a first portion of the plurality of post-consumer high-density polyethylene and polypropylene flakes having a melt index below about 2 g/10 min such that a remaining second portion of the plurality of post-consumer high-density polyethylene and polypropylene flakes has a melt index between about two g/10 min and about 50 g/10 min; (4) forming the second portion of the plurality of post-consumer high-density polyethylene and polypropylene flakes into a plurality of post-consumer high-density polyethylene and polypropylene pellets; (5) after forming the plurality of post-consumer high-density polyethylene and polypropylene flakes into the plurality of post-consumer high-density polyethylene and polypropylene pellets, devolatilizing the plurality of post-consumer high-density polyethylene and polypropylene pellets in a devolatilization chamber to produce a plurality of devolatilized post-consumer high density polyethylene and polypropylene pellets; and (6) providing the plurality of devolatilized post-consumer high-density polyethylene and polypropylene pellets for use in a molding process to produce a plurality of fit-for-food contact articles.

In some embodiments, providing the plurality of devolatilized post-consumer high-density polyethylene and polypropylene pellets for use in the molding process comprises providing the plurality of devolatilized post-consumer high-density polyethylene and polypropylene pellets for use in an injection and compression molding and flexible packaging processes. In various embodiments, the molding process to produce the plurality of fit-for-food contact articles does not require any additives to change the melt flow with the plurality of devolatilized post-consumer high-density polyethylene and polypropylene pellets. In particular embodiments, identifying the first portion of the plurality of post-consumer high-density polyethylene and polypropylene flakes having the melt index below about 2 g/10 min comprises performing at least one of polymer sortation or optical sortation on the plurality of post-consumer high-density polyethylene and polypropylene flakes to identify the first portion having the melt index below about 2 g/10 min.

In various aspects, identifying and discarding the first portion of the plurality of post-consumer high-density polyethylene and polypropylene flakes having the melt index below about 2 g/10 min such that the remaining second portion of the plurality of post-consumer high-density polyethylene and polypropylene flakes has a melt index between about two g/10 min and about 50 g/10 min comprises identifying and discarding the first portion of the plurality of post-consumer high-density polyethylene and polypropylene flakes having the melt index below about 2 g/10 min such that the remaining second portion of the plurality of post-consumer high-density polyethylene and polypropylene flakes has a melt index between about two g/10 min and about 5 g/10 min. In particular aspects, discarding the first portion of the plurality of post-consumer high-density polyethylene and polypropylene flakes comprises discarding a portion of the plurality of post-consumer high-density polyethylene and polypropylene flakes having a density other than a density between about 0.91 g/cm3 and about 0.94 g/cm3.

In some embodiments, the method comprise: (1) separating the second portion of the plurality of post-consumer high-density polyethylene and polypropylene flakes by melt index into: (A) a first plurality having a melt index between about 3 g/10 min and about 10 g/10 min; (B) a second plurality having a melt index between about 10 g/10 min and about 30 g/10 min; and (C) a third plurality having a melt index between about 30 g/10 min and about 50 g/10 min; (D) separately forming the first plurality, the second plurality, and the third plurality into a first plurality of pellets, a second plurality of pellets, and a third plurality of pellets respectively; (E) separately devolatilizing the first plurality of pellets, the second plurality of pellets, and the third plurality of pellets to form a first plurality of devolatilized pellets, a second plurality of devolatilized pellets, and a third plurality of devolatilized pellets; and (F) separately providing each of the first plurality of devolatilized pellets, a second plurality of devolatilized pellets, and a third plurality of devolatilized pellets for use in different molding processes to produce different respective fit-for-food contact articles.

A method of producing fit-for-food contact devolatilized post-consumer thermoplastic polymer pellets derived from higher melt index post-consumer recycled thermoplastic polymer, in some embodiments, comprises: (1) providing higher melt index post-consumer recycled thermoplastic polymer having a melt index between about one g/10 min. and about fifty g/10 min.; (2) forming the higher melt index post-consumer recycled thermoplastic polymer into a plurality of higher melt index polymer pellets; (3) after forming the higher melt index post-consumer recycled thermoplastic polymer into the plurality of higher melt index post-consumer polymer pellets, devolatilizing the plurality of higher melt index post-consumer polymer pellets in a devolatilization chamber to produce a plurality of devolatilized higher melt index post-consumer polymer pellets; and (4) providing the plurality of devolatilized post-consumer high-density polyethylene and polypropylene pellets for use in at least one of an injection molding, compression molding, or flexible packaging processes to produce a plurality of fit-for-food contact articles from the plurality of devolatilized post-consumer high-density polyethylene and polypropylene pellets.

In particular embodiments, the method further comprises: (1) sorting higher melt index post-consumer recycled thermoplastic polymer according to melt index into a first portion of the higher melt index post-consumer recycled thermoplastic polymer and a second portion of the higher melt index post-consumer recycled thermoplastic polymer, the first portion having a higher melt index than the second portion; (2) determining a desired melt index of the plurality of devolatilized post-consumer high-density polyethylene and polypropylene pellets; and (3) selecting the first portion or the second portion of the higher melt index post-consumer recycled thermoplastic polymer to form into the plurality of higher melt index post-consumer polymer pellets based on the desired melt index of the plurality of devolatilized post-consumer high-density polyethylene and polypropylene pellets.

In some embodiments, the method further comprises: (1) forming the first portion of the higher melt index post-consumer recycled thermoplastic polymer into a first plurality of higher melt index polymer pellets; and (2) forming the second portion of the higher melt index post-consumer recycled thermoplastic polymer into a second plurality of higher melt index polymer pellets/In various embodiments, providing the higher melt index post-consumer recycled thermoplastic polymer having the melt index between about one g/10 min. and about fifty g/10 min comprises: (1) providing a plurality of recycled polymer; (2) grinding the plurality of recycled polymer into a plurality of recycled polymer flakes; and (3) identifying and discarding a first portion of the plurality of recycled polymer flakes having a melt index below about 1 g/10 min to leave the higher melt index post-consumer recycled thermoplastic polymer having the melt index between about one g/10 min and about fifty g/10 that comprises a remaining second portion of the plurality of recycled polymer flakes. In various embodiments, identifying the first portion of the plurality of recycled polymer fakes comprises performing at least one of polymer sortation or optical sortation on the plurality of recycled polymer flakes to identify the first portion of the plurality of recycled polymer fakes having the melt index below about 1 g/10 min.

A method of producing fit-for-food contact devolatilized post-consumer thermoplastic polymer pellets derived from higher melt index post-consumer recycled thermoplastic polymer, in particular embodiment, comprises: (1) providing a plurality of recycled polymer; (2) sorting the plurality of recycled polymer according to melt index into a first group of recycled polymer having a first melt index in a first range and a second group of recycled polymer having a second melt index in a second range; (3) forming the first group of recycled polymer into a first group of pellets; (4) forming the second group of recycled polymer into a second group of pellets; (5) separately devolatilizing the first group of pellets and the second group of pellets; (6) identifying a type of food contact recycled article to be produced using recycled polymer; (7) selecting between the first group of devolatilized pellets and the second group of devolatilized pellets based on melt index requirements for the type of food contact recycled article; and (8) providing the selected group of devolatilized pellets for use in producing the type of food contact recycled article.

In some embodiments, the plurality of recycled polymer is derived from a plurality of post-consumer high-density polyethylene and polypropylene bottle and containers caps, closures and lids derived from recycled plastic food grade bottles and containers. In various embodiments, sorting the plurality of recycled polymer according to melt index comprises using a color sortation process, a material sortation process, or both. In particular embodiments, the melt index requirements for the type of food contact recycled article comprise a suitability for injection molding; the first range is between about 3 and about 10 g/10 min; and the selected group of devolatilized pellets is the first group of devolatilized pellets. In some aspects, sorting the plurality of recycled polymer according to melt index comprises using a color sortation process to separate colored recycled polymer in the plurality of recycled polymer from clear recycled polymer in the plurality of recycled polymer. In various aspects, the first range comprises a range of between about 2 g/10 min and about 10 g/10 min. In some embodiments, the first range comprises a range of between about 2 g/10 min and about 5 g/10 min. In some aspects, the method comprises discarding a third group of recycled polymer from the plurality of recycled polymer having a melt index outside of the first range and the second range.

### BRIEF DESCRIPTION OF THE DRAWINGS

Having described various embodiments in general terms, reference will now be made to the accompanying drawings, which are not necessarily drawn to scale, and wherein:

FIG. 1 depicts a high-level overview of a process for recycling post-consumer high density polyethylene and polypropylene materials according to various embodiments described herein;

FIG. 2 depicts a high-level overview of a process for recycling post-consumer high density polyethylene and polypropylene materials according to various other embodiments described herein;

FIG. 3 depicts a high-level overview of a process for recycling post-consumer high density polyethylene and polypropylene materials according to various other embodiments described herein; and

FIG. 4 depicts an exemplary devolatilization chamber according to various embodiments.

### DETAILED DESCRIPTION

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

Post-consumer plastics recycling processes for producing new articles from post-consumer recycled articles may be required to assure that post-consumer recycled material from the post-consumer recycled articles satisfies pre-defined material requirements for the articles into which the articles are being recycled. For example, certain processes for producing particular articles have particular requirements with respect to a melt index of the source material. Molding processes, such as injection or compression molding or flexible packaging processes may utilize materials with a relatively higher melt index than other processes. As such, in order to produce new articles from post-consumer recycled materials, especially for fit-for-food contact post-consumer recycled materials using particular molding processes (e.g., injection &compression molding or flexible packaging), it may be necessary to source post-consumer recycled materials that have a sufficiently higher melt index such that the post-consumer recycled materials are suitable for use in those particular molding processes.

Challenges with respect to producing higher melt index articles via injection and compression molding or flexible packaging may be exacerbated, for example, if the articles into which the articles are being recycled are fit-for-food contact articles (e.g., will be used to produce articles that must satisfy one or more fit-for-food contact requirements so that the articles can be used, for example, as packaging for food and beverage products). For example, limonene is an aromatic compound that can be found in food, cosmetics, and detergent and cleaning containers. As used herein, “fragrance-free or “suitable for food contact” or fit-for-food contact may mean having less than about 320 ppb of limonene. In particular aspects, certain regulatory agencies (e.g., the U.S. Food and Drug Administration) may regulate the threshold amount of limonene allowed in approved food contact applications. Certain agencies may require, for example, a limonene content of less than about 320 ppb in food contact applications. One skilled in the art will recognize that the process described herein may be utilized to meet any other limonene content requirements (e.g., as requirements change in one or more jurisdictions) or other marker content requirements.

A particular method for producing fit-for-food contact articles from post-consumer recycled materials may include, for example: (1) providing a plurality of post-consumer recycled polymer articles having at least a particular melt index and sourced from food packaging; (2) grinding the post-consumer recycled polymer articles into high melt index polymer flakes, by using optical and polymer sortation technologies to separate the higher melt index flakes; (3) forming the higher melt index polymer flakes into higher melt index polymer pellets; (4) devolatilizing the higher melt index polymer pellets in a devolatilization chamber; (5) providing the devolatilized higher melt index polymer pellets for use in a molding process to produce recycled fit-for-food contact articles. In some aspects, the process involves identifying and discarding polymer flakes that are outside a desired range of melt index (e.g., less than about 2 g/10 min) prior to forming the flakes into pellets. In various aspects, the high melt-index flakes are further separated into separate groups having separate ranges of melt index (e.g., a first group having a melt index between about 3 and about 10 g/10 min, a second group having a melt index between about 10 and about 30 g/10 min, and a third group having a melt index between about 30 and about 50 g/10 min). In this way, the process may result in devolatilized groups of higher melt index pellets, each of which may be suitable for use in different molding applications (e.g., injection molding) or different ultimate products or articles (e.g., bottle caps v. yogurt lids, etc.).

In a particular example, the process may use post-consumer recycled polymer articles derived from post-consumer high-density polyethylene and polypropylene bottle caps, closures and lids sourced from food packaging. In general, post-consumer high-density polyethylene and polypropylene bottle caps, closures and lids may not be utilized effectively in current recycling processes. For example, the bottle caps, closures and lids are typically separated (e.g., in a float tank or density separation) from the plastic bottles or containers (comprising polyethylene terephthalate or other polymers) during a typical PET or polypropylene recycling process. For example, in case of PET recycling processes, once caps and closures are separated, the fit-for-food contact PET is utilized in various recycling applications and food and beverage packaging, while the caps and closures (comprising post-consumer high-density polyethylene and polypropylene sourced from food and beverage packaging) are often discarded or used in a very low-end products such as pallets or similar products. As such, the process described herein, in various embodiments, may source the post-consumer high density polyethylene and polypropylene caps, closures, and lids (e.g., ground polyethylene and polypropylene caps sourced from recycled PET bottles) for use in the process. In such embodiments, the process may optionally omit steps related to grinding the high-density polyethylene and polypropylene caps and closures (e.g., because the caps and closures may be sourced in a ground state).

In various other embodiments, the process may include sourcing any other suitable higher melt index polymer that has been certified to be food safe (e.g., because the polymer was sourced from a food-safe recycled article or container). In some aspects, the process described herein may enable the production of fit-for-food contact articles from 100% post-consumer recycled content. In such embodiments, the post-consumer recycled content may include fit-for-food contact recycled polymer (e.g., post-consumer high density polyethylene and polypropylene) with a melt index that is sufficiently higher for use in an injection and compression molding or flexible packaging processes to produce the new fit-for-food contact articles. In some embodiments, the process involves the use of post-consumer recycled content having a melt index of up to about 50 g/10 min. In some aspects, the process eliminates the need for additives to produce the articles such as, for example, 10% or more additives (e.g., virgin high melt LLDPE, virgin high melt HDPE, etc. or additives). In some aspects, the process eliminates the need of r additives to change the melt flow of the plurality of devolatilized post-consumer high-density polyethylene and polypropylene pellets.

### Exemplary Recycling Process

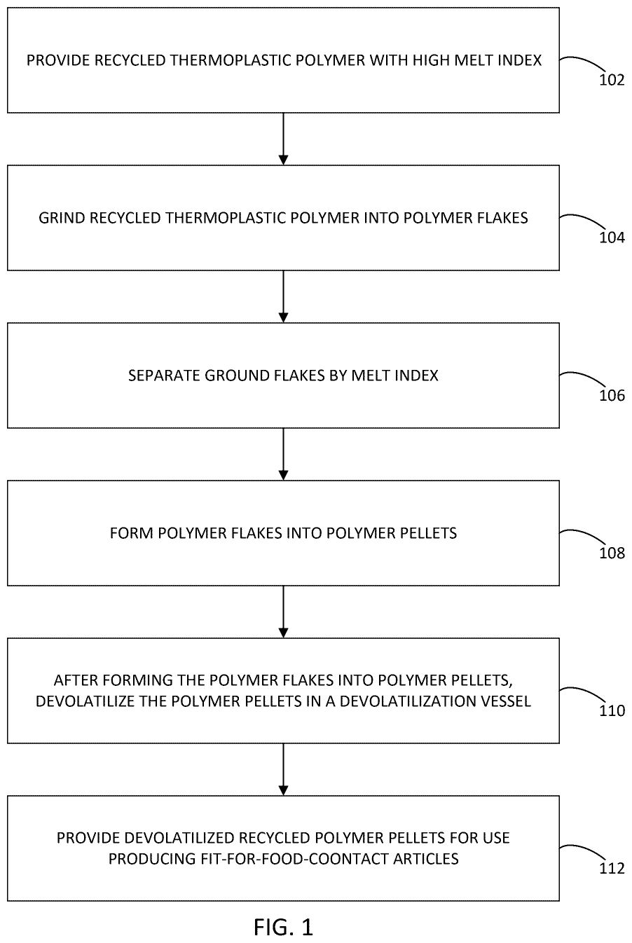

FIG. 1 depicts an overview of a process for recycling post-consumer high density polyethylene and polypropylene materials according to various embodiments. Although the process below is described using specific examples, it should be understood that in various other embodiments, particular steps may be omitted, additional processing steps may be performed, or particular steps may be combined or separated.

In various aspects, a process for recycling higher melt index thermoplastic polymers may include a series of processing steps. FIG. 1 depicts exemplary process steps for forming higher melt index thermoplastic polymer pellets from post-consumer recycled thermoplastic polymer material (e.g., bottles, caps, closures, lids, etc.). In particular embodiments, the higher melt index thermoplastic polymer pellets may be utilized in a molding process to produce fit-for-food contact articles (e.g., food and/or beverage containers or other articles).

Step 1 (102): Provide Post-Consumer Recycled Thermoplastic Polymer with Higher Melt Index

In particular embodiments, the process for producing fit-for-food contact articles from recycled polymer includes providing recycled thermoplastic polymer at step 102. In particular aspects, the process involves providing recycled thermoplastic polymer having a high melt index (e.g., a melt index above about two (2) g/10 min). In various embodiments, the post-consumer recycled thermoplastic polymer comprises post-consumer high-density polyethylene, polypropylene, or both. In some embodiments, the post-consumer recycled thermoplastic polymer (e.g., high density polyethylene and/or polypropylene) comprises a post-consumer recycled polymer derived from fit-for-food contact articles (e.g., food containers, plastic bottles, etc.). In various embodiments, the post-consumer recycled material is sourced from curbside post-consumer recycled materials and collection systems. In a particular embodiment, the recycled thermoplastic polymer comprises high density polyethylene and polypropylene bottle caps, and closures. In some aspects, these bottle caps and closures may be sourced from recycled food or beverage bottles or containers. In various embodiments, the recycled bottle caps, closures, and lids may come in the form of flakes separated from recycled PET during a bottle recycling process or other recycling processes. In some embodiments, the bottle caps, closures, and lids may represent waste that is generally discarded during a plastic bottle or other container's recycling processes. In other aspects, the bottle caps, closures, and/or lids may traditionally be recycled into low end products that are not fit-for-food contact. In particular embodiments, the post-consumer recycled thermoplastic polymer may have a melt index of at least about one g/10 min and up to about fifty (50) g/10 min. In other embodiments, the post-consumer recycled thermoplastic polymer (e.g., bottle caps, closures, and lids) may have a melt index between about two (2) and about five (5) g/10 min. In certain aspects, the recycled caps, closures, and lids may have a density between about 0.91 and about 0.94 g/cm³.

Step 2 (104): Grind Post-Consumer Recycled Thermoplastic Polymer into Polymer Flakes

In particular embodiments, the process for producing fit-for-food contact articles from recycled polymer continues, at step 104, the process involves performing one or more pre-processing steps on the higher melt index recycled polymer. For example, in particular embodiments (e.g., in which the recycled polymer is provided in the form of bales of recycled polymer products, such as bottles), the process involves bale breaking (e.g., to break up bales of the recycled articles). In some aspects, the process may involve a bottle pre-wash, metal separation, and/or manual sortation prior to size reduction (e.g., grinding, shredding). In various aspects, the recycled polymer provided at Step 102 is provided in already ground form. In such embodiments, the various bale breaking and bottle washing steps mentioned above may be omitted. In particular embodiments, the process includes a hot wash and hot rinse of the ground polymer flakes.

The process may then involve a density and/or polymer sortation for separating the flakes into groups based on their density, color, material-type, etc. For example, as may be understood in light of this disclosure, certain sources of recycled polymer may provide recycled polymer flakes derived primarily from materials having a melt index in a desirable range for the process described herein. Such providers may include, for example, PET recyclers, that may provide recycled caps recovered from PET bottles in a PET recycling process that have generally been separated from the PET components of those bottles. As such, materials sourced from such providers may require fewer pre-processing steps in order to suitably separate the recycled polymer flakes in a desired melt index range for use in the process described herein. In some aspects, flakes having a density between about 0.9 and 0.94 g/cm³ are separated from the remaining flakes and maintained for further processing.

### Step 3 (106): Separate Ground Flakes by Melt Index

In various aspects, the high melt-index flakes are further separated into separate groups having separate ranges of melt index (e.g., a first group having a melt index between about 3 and about 10 g/10 min, a second group having a melt index between about 10 and about 30 g/10 min, and a third group having a melt index between about 30 and about 50 g/10 min). In this way, the process may result in devolatilized groups of higher melt index pellets, each of which may be suitable for use in different molding applications (e.g., injection molding) or different ultimate products or articles (e.g., bottle caps v. yogurt lids, etc.). In some aspects, injection molding applications require polymer having a melt index of between about 2 g/10 min and about 10 g/10 min (e.g., between 3 and 10 g/10 min). As such, it may be desirable to separate recycled polymer having a melt index in such a range and pelletizing and devolatilizing that material separately so it can be provided for and put to the particular application (e.g., injection molding of food-contact articles).

In some aspects, source recycled polymer (e.g., post-consumer high density polyethylene and polypropylene materials) may include both high and low melt index materials. Some recyclers may separate and provide higher melt index materials that are substantially uniform in their melt index (e.g., having a higher melt index throughout), such as PET recyclers. Other multi-recovery facilities may provide recycled polymer having a range of melt indices in a single bale, container, etc. In this way, it may be desirable to separate recycled material (e.g., recycled polymer flakes) according to melt index.

In one example, the process may involve separating a plurality of flakes into: (1) first plurality having a melt index between about 3 g/10 min and about 10 g/10 min; (2) a second plurality having a melt index between about 10 g/10 min and about 30 g/10 min; and (3) a third plurality having a melt index between about 30 g/10 min and about 50 g/10 min;

In some aspects, melt index sortation may be achieved (e.g., substantially achieved) through sortation according to other parameters. For example, the process may involve color sortation (using optical sortation techniques using any suitable optical sorting system) to separate the polymer flakes by color (e.g., color v. clear, color by color, etc.). In some aspects, clear caps/closures/lids/etc. may have a different melt index than colored caps/closures/lids/etc. Similarly caps/closures/lids/etc. of different colors may have different melt indices. By color sorting the recycled flakes (e.g., derived from post-consumer high-density polyethylene and polypropylene bottle and containers caps, closures and lids derived from recycled plastic food grade bottles and containers), the process may enable a segmentation of ranges of melt indices such that the ultimately produced devolatilized pellets can be limited to a particular range of melt indices (e.g., or can be grouped according to melt index). In this way, the process may enable recycling of the devolatilized pellets and providing of the pellets according to their ultimate use (e.g., injection molding, formation into yogurt lids, formation into caps for PET bottles, etc.).

In other embodiments, the polymer flakes may be separated according to a polymer sortation process (e.g., to separate post-consumer high-density polyethylene bottle caps from polypropylene yogurt lids, etc.). In other aspects, other low melt index materials are separated and discarded (e.g., other contaminants).

Step 4 (108): Form Polymer Flakes into Polymer Pellets

In various embodiments, the polymer flakes are formed into polymer pellets, for example, using any suitable extrusion and pelletizing processes. In particular aspects, the process may utilize any suitable pelletizing process prior to devolatilization. In some aspects, the melt index separation described above with respect to the polymer flakes may be performed on the pellets.

### Step 5 (110): Devolatilize the Polymer Pellets in a Devolatilization Vessel

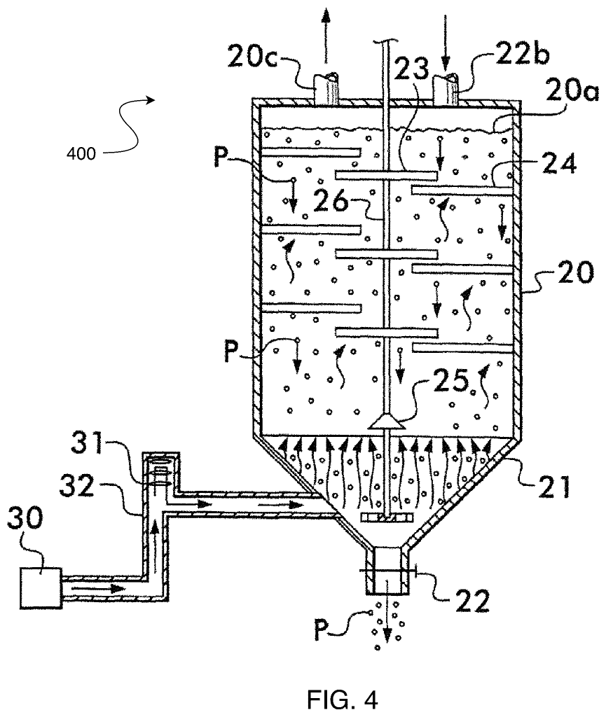

In various embodiments, following the extrusion and pelletizing processes the post-consumer recycled polymer, the process involves devolatilizing the pellets in a devolatilization chamber (e.g., FIG. 4). In particular embodiments, the devolatilization process reduces the concentration of volatile, semi-volatile, polar, and non-polar components of the pellets (e.g., resulting in a marker like limonene content below about 320 ppb, the FDA threshold for polyolefins). Without the devolatilization step, the pellets may be unsuitable for use in food contact articles. An exemplary devolatilization process is described below.

### Step 6 (112): Provide Devolatilized Recycled Polymer Pellets for Use in Producing Fit-For-Food Contact Articles

In particular embodiments, the devolatilized pellets may be provided for use in producing fit-for-food contact articles. For example, the process may involve providing the plurality of devolatilized post-consumer high-density polyethylene and polypropylene pellets for use in a molding process to produce a plurality of fit-for-food contact articles. In some aspects, the devolatilized pellets are provided according to a required melt index for their ultimate use. For example, different devolatilized groups of higher melt index pellets may each be suitable for use in different molding applications (e.g., injection molding) or different ultimate products or articles (e.g., bottle caps v. yogurt lids, etc.). In some aspect's, the pellets may be provided for use in at least one of an injection molding, compression molding, or flexible packaging processes to produce a plurality of fit-for-food contact articles. In some aspects, the process for which the pellets will be used may determine which portion of pellets (e.g., having a particular range of melt indices) will be selected for provision.

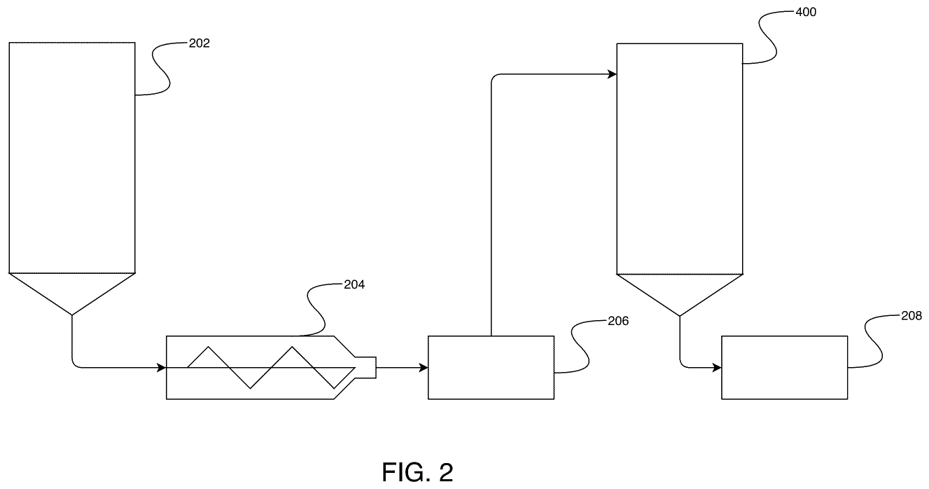

FIG. 2 depicts an overview of a process for recycling post-consumer high density polyethylene and polypropylene materials according to various embodiments. Although the process below is described using specific examples, it should be understood that in various other embodiments, particular steps may be omitted, additional processing steps may be performed, or particular steps may be combined or separated.

In various aspects, a process for recycling higher melt index thermoplastic polymers may include a series of processing steps. FIG. 2 depicts exemplary process steps for forming higher melt index thermoplastic polymer pellets from post-consumer recycled thermoplastic polymer material (e.g., bottles, caps, closures, lids, etc.). In particular embodiments, the higher melt index thermoplastic polymer pellets may be utilized in a molding process to produce fit-for-food contact articles (e.g., food and/or beverage containers or other articles).

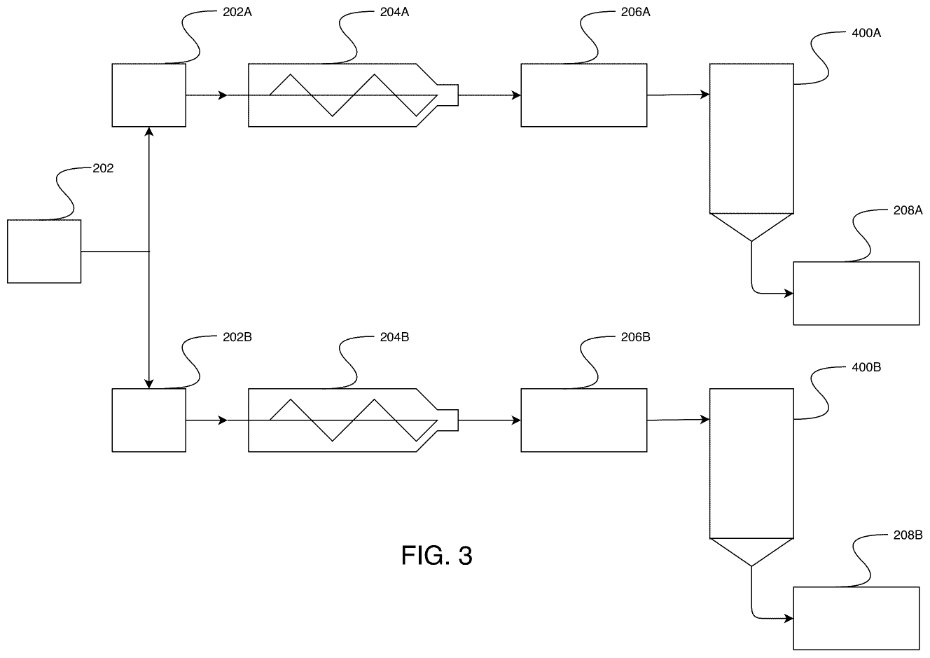

In some aspects, as shown in FIG. 3, the post-consumer recycled thermoplastic polymer material (e.g., bottles, caps, closures, lids, etc.) is stored in a silo 202 or other container. In various aspects, the material in the silo comprises flakes (e.g., which may have been sourced in flake form, ground into flakes as described herein, or ground into finer flakes from an initially sourced flake size). In some aspects, the flake silo 202 or other container feeds into an extruder 204 which forms the flakes into pellets. In various aspects, the pellets include pellets of a conventional size. In particular embodiments, the pellets comprise flat, circular discs, having a diameter of about 0.0625 inch (1.5875 mm) and a thickness of about 1-2 mm. In particular aspects, the pellets have a density between about 0.91 g/cm³ and about 0.94 g/cm³.

In various aspects, the pellets produced by the extruder can then be stored in a second container 206 (e.g., silo, etc.). In various aspects, the stored pellets may still contain some odor from the food containers from which they were sourced, making them not suitable to be used in direct contact with food products after recycling (i.e., at least prior to devolatilization as described herein). The pellets may then be fed into a devolatilization chamber 400 in which the pellets are subjected to hot gas and agitation for a predetermined period of time, after which they are discharged from the vessel (e.g., devolatilization chamber 400) into suitable container(s) 208.

In some aspects, as shown in FIG. 3, the post-consumer high density polyethylene and polypropylene materials (e.g., flakes) may be separated prior to the pelletizing and devolatilization process. The flakes may be separated, for example, according to melt index (e.g., such that the flakes are divided into a first plurality of flakes having a melt index in a first range, and a second plurality of flakes having a melt index in a second range). In other aspects, the flakes may be further divided by melt index (e.g., into pluralities of flakes having any suitable range of melt indices).

For example, as shown in FIG. 3, the flakes may be separated into one or more separate silos or containers (e.g., 202A, 202B) prior to extrusion in respective extruders (e.g., 204A, 204B). The pellets produced through the respective extruders 204A, 204B may then be stored intermediately in respective containers 206A, 206B (e.g., silos) prior to devolatilization in respective devolatilization chambers 400A, 400B. Finally, the respectively devolatilized pellets may be stored at least temporarily in respective containers 208A, 208B. In the example shown in FIG. 3, the flakes are separated into two extrusion/devolatilization lines according to melt index. In other embodiments, the flakes may be separated into any suitable number of extrusion/devolatilization lines according to any suitable factor (e.g., melt index, etc.).

FIG. 4 depicts an exemplary devolatilization chamber 400 that may be utilized in the context of the process described above. In some aspects, as may be understood from FIG. 4, the devolatilization chamber comprises an upright cylindrical vessel 20 having a substantially conical (e.g., conical) bottom wall 21 with a valved discharge 22. Pellets P may be charged into the upper end 20a of the vessel through an inlet 22b and may then be discharged from the bottom after having been contacted with hot air. The hot air may be filtered and admitted into the bottom of the chamber and flowed upwardly in the vessel to exhaust from an outlet 20c at the top of the vessel. The pellets P may move downwardly aided by gravity at a slow rate while the hot air, at a temperature in a range of between about 50° C. to about 125° C. flows upwardly at a vertical linear velocity of between about 1.0 ft/sec. (0.3048 m/sec.) to about 2.1 ft/sec. (0.6400 m/sec.). In particular aspects, the air temperature in the chamber ranges from between about 90° C. to about 125° C.

While migrating downwardly, the pellets P may be in the form of a loosely confined mass that is continuously stirred by a series of paddles 23 that are disposed between radially inwardly extending shelves 24 in the chamber. The pellet output rate may be adjusted to ensure a residence time of the pellets P of between about 1 to about 15 hours in the chamber. In particular other embodiments, the residence time may be between about 3 hours and about 10 hours. In some embodiments, the steady state temperature of the hot air measured between the bottom hot air inlet manifold and the top of the vessel may be maintained in a range of about 104° C. to about 116° C. In particular aspects, the air is flowed by a blower 30 and is measured and maintained through a heater 31 connected to a manifold 32 in communication with the vessel 20 adjacent the bottom wall 21. As the pellets P descend downwardly toward the bottom of the devolatilization chamber, they may be flowed radially outward by a substantially conical (e.g., conical) baffle 25 mounted adjacent the lower end of the cylindrical portion of the chamber. In various embodiments, the baffle 25 may be connected to a central vertical shaft 26 which mounts the agitator paddles 23. In various aspects, the baffle 25 may rotate in unison with the paddles. The baffle 25 diverts the general flow of pellets radially outwardly toward the upper end of the conical bottom wall, and this functions to control downward flow of pellets centrally of the devolatilization chamber by inhibiting undesirable flow during periods of discharge from the bottom through the bottom air lock valve 22 which discharges pellets cyclically in slugs.

The conical baffle 25 has a peripheral diameter that is in a range of about 1% to about 1/9 of the inside diameter of the devolatilization chamber where its cylindrical wall merges with its frusta-conical bottom wall. The baffle 25 has an angle of inclination, measured at its periphery, in a range of between about 30° to about 70° relative to horizontal.

### Conclusion

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

It should be understood in light of this disclosure that a range describing a melt index is intended to capture and disclose every rational number value between the upper and lower bounds of that range. For example, a melt index range of between about 2 and about 50 g/10 min is intended to capture and disclose every rational number in the range between 2 and 50 (e.g., 2.0, 2.0001, 2.001, 2.01 . . . 49.99, 49.999, 49.9999, 50.0 and so on, including each rational number value between 2 and 50 not listed). In addition, any described range (e.g., describing a range of densities, range of melt indexes, etc.) is intended to capture and disclose every range within the described range (e.g., between about 2 and about 50 is intended to disclosure and capture a range between about 2 and about 5, between about 3 and about 10, between about 10 and about 30, between about 30 and about 50, and so on). Additionally, terms such as “about,” “substantially,” etc., when used to modify structural descriptions or numerical values, are intended to capture the stated shape, value, etc. as well as account for slight variations as a result of, for example, manufacturing tolerances. For example, the term “substantially rectangular” is intended to describe shapes that are both exactly rectangular (e.g., have four sides that meet at ninety degree angles) as well as shapes that are not quite exactly rectangular (e.g., shapes having four sides that meet at an angle in an acceptable tolerance of ninety degrees, such as 90°+/−4°). The term about two (2) g/10 min for example, is intended to describe and disclosure melt indices within a degree of tolerance of the disclosed melt index (e.g., such as 2+/−0.4). Furthermore, although composite compositions are generally described as having a particular component making up a particular percentage of the composition by weight, it should be understood that other embodiments may include those components as the disclosed percentage by volume, mass, or other suitable measure.

What is claimed is:

1. A method of producing post-consumer recycled high-density polyethylene or polypropylene pellets, fit-for-food contact for use in molding processes requiring higher melt index material, the method comprising:
providing a plurality of post-consumer high-density polyethylene and polypropylene bottle and containers caps, closures and lids derived from recycled plastic food grade bottles and containers;
grinding the plurality of post-consumer high-density polyethylene and polypropylene caps, closures and lids into a plurality of post-consumer high-density polyethylene and polypropylene flakes;
identifying and discarding a first portion of the plurality of post-consumer high-density polyethylene and polypropylene flakes having a melt index below about 2 g/10 min such that a remaining second portion of the plurality of post-consumer high-density polyethylene and polypropylene flakes has a melt index between about two g/10 min and about 50 g/10 min;
forming the second portion of the plurality of post-consumer high-density polyethylene and polypropylene flakes into a plurality of post-consumer high-density polyethylene and polypropylene pellets;
after forming the plurality of post-consumer high-density polyethylene and polypropylene flakes into the plurality of post-consumer high-density polyethylene and polypropylene pellets, devolatilizing the plurality of post-consumer high-density polyethylene and polypropylene pellets in a devolatilization chamber to produce a plurality of devolatilized post-consumer high density polyethylene and polypropylene pellets; and
providing the plurality of devolatilized post-consumer high-density polyethylene and polypropylene pellets for use in a molding process to produce a plurality of fit-for-food contact articles.

2. The method of claim 1, wherein providing the plurality of devolatilized post-consumer high-density polyethylene and polypropylene pellets for use in the molding process comprises providing the plurality of devolatilized post-consumer high-density polyethylene and polypropylene pellets for use in an injection and compression molding and flexible packaging processes.

3. The method of claim 1, wherein the molding process to produce the plurality of fit-for-food contact articles does not require any additives to change the melt flow with the plurality of devolatilized post-consumer high-density polyethylene and polypropylene pellets.

4. The method of claim 1, wherein identifying the first portion of the plurality of post-consumer high-density polyethylene and polypropylene flakes having the melt index below about 2 g/10 min comprises performing at least one of polymer sortation or optical sortation on the plurality of post-consumer high-density polyethylene and polypropylene flakes to identify the first portion having the melt index below about 2 g/10 min.

5. The method of claim 1, wherein identifying and discarding the first portion of the plurality of post-consumer high-density polyethylene and polypropylene flakes having the melt index below about 2 g/10 min such that the remaining second portion of the plurality of post-consumer high-density polyethylene and polypropylene flakes has a melt index between about two g/10 min and about 50 g/10 min comprises identifying and discarding the first portion of the plurality of post-consumer high-density polyethylene and polypropylene flakes having the melt index below about 2 g/10 min such that the remaining second portion of the plurality of post-consumer high-density polyethylene and polypropylene flakes has a melt index between about two g/10 min and about 5 g/10 min.

6. The method of claim 1, wherein discarding the first portion of the plurality of post-consumer high-density polyethylene and polypropylene flakes comprises discarding a portion of the plurality of post-consumer high-density polyethylene and polypropylene flakes having a density other than a density between about 0.91 g/cm³ and about 0.94 g/cm³.

7. The method of claim 1, further comprising:
separating the second portion of the plurality of post-consumer high-density polyethylene and polypropylene flakes by melt index into:
a first plurality having a melt index between about 3 g/10 min and about 10 g/10 min;
a second plurality having a melt index between about 10 g/10 min and about 30 g/10 min; and
a third plurality having a melt index between about 30 g/10 min and about 50 g/10 min;
separately forming the first plurality, the second plurality, and the third plurality into a first plurality of pellets, a second plurality of pellets, and a third plurality of pellets respectively;
separately devolatilizing the first plurality of pellets, the second plurality of pellets, and the third plurality of pellets to form a first plurality of devolatilized pellets, a second plurality of devolatilized pellets, and a third plurality of devolatilized pellets; and
separately providing each of the first plurality of devolatilized pellets, a second plurality of devolatilized pellets, and a third plurality of devolatilized pellets for use in different molding processes to produce different respective fit-for-food contact articles.

8. A method of producing fit-for-food contact devolatilized post-consumer thermoplastic polymer pellets derived from higher melt index post-consumer recycled thermoplastic polymer, the method comprising:
providing higher melt index post-consumer recycled thermoplastic polymer having a melt index between about one g/10 min. and about fifty g/10 min.;
forming the higher melt index post-consumer recycled thermoplastic polymer into a plurality of higher melt index polymer pellets;
after forming the higher melt index post-consumer recycled thermoplastic polymer into the plurality of higher melt index post-consumer polymer pellets, devolatilizing the plurality of higher melt index post-consumer polymer pellets in a devolatilization chamber to produce a plurality of devolatilized higher melt index post-consumer polymer pellets; and
providing the plurality of devolatilized post-consumer high-density polyethylene and polypropylene pellets for use in at least one of an injection molding, compression molding, or flexible packaging processes to produce a plurality of fit-for-food contact articles from the plurality of devolatilized post-consumer high-density polyethylene and polypropylene pellets.

9. The method of claim 8, wherein the method further comprises:
sorting higher melt index post-consumer recycled thermoplastic polymer according to melt index into a first portion of the higher melt index post-consumer recycled thermoplastic polymer and a second portion of the higher melt index post-consumer recycled thermoplastic polymer, the first portion having a higher melt index than the second portion;
determining a desired melt index of the plurality of devolatilized post-consumer high-density polyethylene and polypropylene pellets; and
selecting the first portion or the second portion of the higher melt index post-consumer recycled thermoplastic polymer to form into the plurality of higher melt index post-consumer polymer pellets based on the desired melt index of the plurality of devolatilized post-consumer high-density polyethylene and polypropylene pellets.

10. The method of claim 8, wherein the method further comprises:
forming the first portion of the higher melt index post-consumer recycled thermoplastic polymer into a first plurality of higher melt index polymer pellets; and
forming the second portion of the higher melt index post-consumer recycled thermoplastic polymer into a second plurality of higher melt index polymer pellets.

11. The method of claim 8, wherein providing the higher melt index post-consumer recycled thermoplastic polymer having the melt index between about one g/10 min. and about fifty g/10 min comprises:
providing a plurality of recycled polymer;
grinding the plurality of recycled polymer into a plurality of recycled polymer flakes; and
identifying and discarding a first portion of the plurality of recycled polymer flakes having a melt index below about 1 g/10 min to leave the higher melt index post-consumer recycled thermoplastic polymer having the melt index between about one g/10 min and about fifty g/10 that comprises a remaining second portion of the plurality of recycled polymer flakes.

12. The method of claim 11, wherein identifying the first portion of the plurality of recycled polymer fakes comprises performing at least one of polymer sortation or optical sortation on the plurality of recycled polymer flakes to identify the first portion of the plurality of recycled polymer fakes having the melt index below about 1 g/10 min.

13. A method of producing fit-for-food contact devolatilized post-consumer thermoplastic polymer pellets derived from higher melt index post-consumer recycled thermoplastic polymer, the method comprising:
providing a plurality of recycled polymer;
sorting the plurality of recycled polymer according to melt index into a first group of recycled polymer having a first melt index in a first range and a second group of recycled polymer having a second melt index in a second range;
forming the first group of recycled polymer into a first group of pellets;
forming the second group of recycled polymer into a second group of pellets;
separately devolatilizing the first group of pellets and the second group of pellets;
identifying a type of food contact recycled article to be produced using recycled polymer;
selecting between the first group of devolatilized pellets and the second group of devolatilized pellets based on melt index requirements for the type of food contact recycled article; and
providing the selected group of devolatilized pellets for use in producing the type of food contact recycled article.

14. The method of claim 13, wherein the plurality of recycled polymer is derived from a plurality of post-consumer high-density polyethylene and polypropylene bottle and containers caps, closures and lids derived from recycled plastic food grade bottles and containers.

15. The method of claim 13, wherein sorting the plurality of recycled polymer according to melt index comprises using a color sortation process, a material sortation process, or both.

16. The method of claim 13, wherein:
the melt index requirements for the type of food contact recycled article comprise a suitability for injection molding;
the first range is between about 3 and about 10 g/10 min; and
the selected group of devolatilized pellets is the first group of devolatilized pellets.

17. The method of claim 13, wherein sorting the plurality of recycled polymer according to melt index comprises using a color sortation process to separate colored recycled polymer in the plurality of recycled polymer from clear recycled polymer in the plurality of recycled polymer.

18. The method of claim 13, wherein the first range comprises a range of between about 2 g/10 min and about 10 g/10 min.

19. The method of claim 13, wherein the first range comprises a range of between about 2 g/10 min and about 5 g/10 min.

20. The method of claim 13, further comprising discarding a third group of recycled polymer from the plurality of recycled polymer having a melt index outside of the first range and the second range.
